(19) United States
(12) Patent Application Publication
(10) Pub. No.: US 2009/0153703 A1
(43) Pub. Date: Jun. 18, 2009

(54) Method and device for processing digital photographs

(76) Inventor: Feng-Hsing Wang, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,181

(22) Filed: Mar. 3, 2008

(30) Foreign Application Priority Data
Dec. 12, 2007 (TW) 96147436

(51) Int. Cl. H04N 5/262; G06K 9/60

(52) U.S. Cl. 348/239; 382/302; 348/E05.051

(57) ABSTRACT

A method for processing digital photographs is provided. It includes the steps of: selecting a digital photograph; selecting a template, which defines plural grid cells arranged in a checkered pattern; dividing the digital photograph into non-overlapping image cells; processing each image cell of the digital photograph in a mosaic way; and respectively filling the average color of each image cell of the digital photograph to the corresponding grid cell of the template. Digital photographs can provide attraction and amusement by applying this method.

### BACKGROUND OF THE INVENTION

1. Field of the Invention

The present invention is related to a processing method and device, and more particularly to a method and device for processing digital photographs.

2. Description of Related Art

Owing to the development of digital processing technology, a large amount of electronic products related to digitization have entered the market. Among all these products, the digital camera is the most popular one since it can provide the user a convenient operation for photographing and viewing photographs rapidly.

Currently, for offering different photographing effects, the digital camera might have different modes for selection, or might provide different post-production functions for editing the images, for example, the user can add a frame to the photograph, adjust image properties, or tailor the photograph.

However, currently, the edition functions provided for digital photographs always focus on modifying or beautifying photographs. There still has the lacks of functions for increasing the interest and amusement of photographs.

### SUMMARY OF THE INVENTION

Therefore, the object of the present invention is to provide a method and device for processing digital photographs. It can represent the content of a digital photograph in another form according to the template selected, so that the processed result can bring attraction and amusement for the user.

To solve the shortages described above, the present invention provides a method for processing digital photographs including: selecting a digital photograph; selecting a template, which defines multiple grid cells arranged in a checkered pattern; dividing the digital photograph into non-overlapping image cells; processing each image cell of the digital photograph in a mosaic way; respectively filling the color of each image cell of the digital photograph to the corresponding grid cell of the template, and saving the result as an output file.

For solving the problem described above, the present invention also provides a device for processing digital photograph including: a template database, a control module, an image processing module, and a color-filling module. The template database stores at least one template, which defines multiple grid cells arranged in a checkered pattern. The image processing module divides the digital photograph into a number of non-overlapping image cells and applies the mosaic process to each of the image cells. The color-filling module respectively fills the average color of each image cells to the grid cells of the template used, and saves the result as an output file. The control module controls the image processing module, the color-filling module, and other modules to cooperate together.

By implementing the above description, the present invention can represent the content of a digital photograph in interesting and creative form according to the template chosen by the user. Handheld devices like digital cameras applying the present invention will provide users the extra amusement and fun while operating the devices. Thus, the present invention can enhance the attraction and interest of the handheld devices.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a block diagram showing the device for processing digital photograph in a preferred embodiment of the present invention;

FIGS. 2A˜2D are the schematic views showing the template examples of the present invention;

FIG. 3 is a flow chart showing the method for processing digital photograph in a preferred embodiment of the present invention; and

FIGS. 4A˜4C are the schematic views showing an example of processing a digital photograph by applying the present invention, where FIG. 2A is employed as the template used.

### DETAILED DESCRIPTION OF PREFERRED EMBODIMENTS

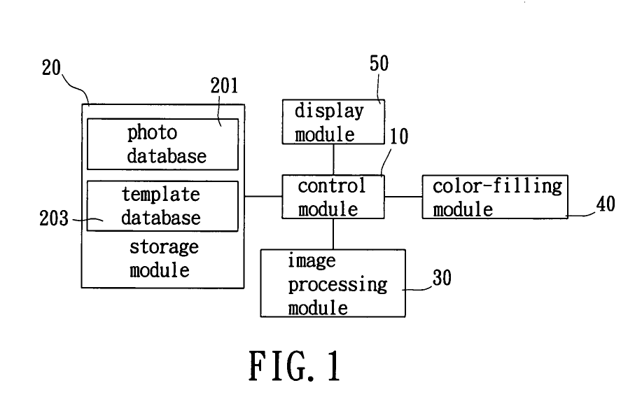

The main concept of the present invention is to employ the mosaic process to a digital photograph, and then apply the color information of the processed result to a template, so that the content of the digital photograph can be represented in interesting and creative form. Please refer to FIG. 1, which is a functional block diagram showing the device for processing digital photographs according to the present invention. In the embodiment, the processing device comprises a control module 10, a storage module 20, an image processing module 30, a color-filling module 40 and a display module 50.

The control module 10 is respectively coupled to the storage module 20, the image processing module 30, the color-filling module 40 and the display module 50. It controls all the modules to operate together and assigns or passes the necessary working data to each module. Generally, the control module 10 utilizes the hardware and software to complete the works described above. For example, the embodiment can be implemented by utilizing a programmable microprocessor with firmware installed and related peripheral circuits (such as operation interface).

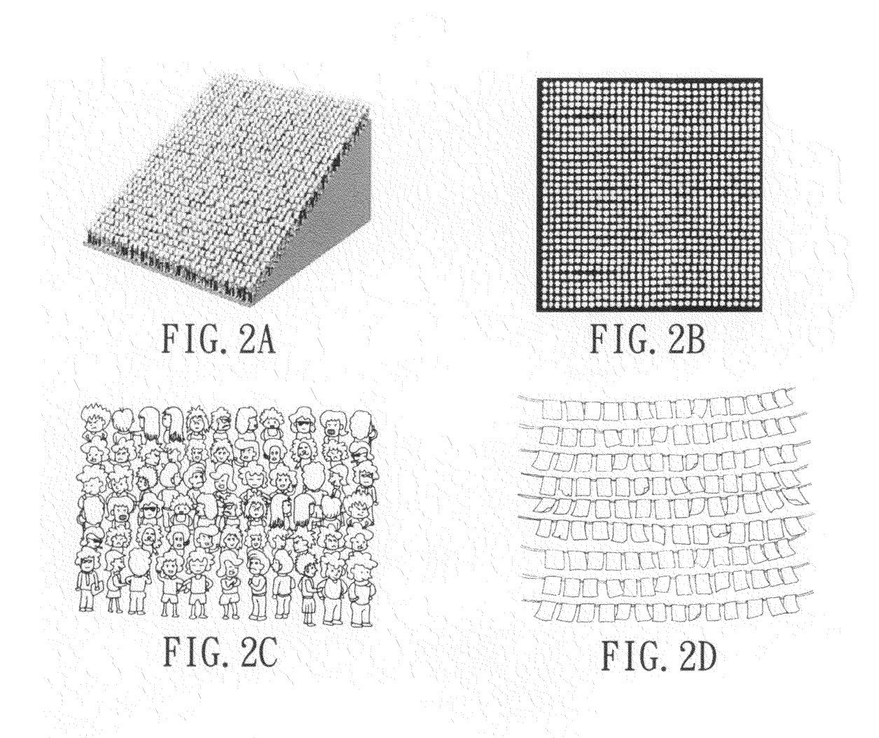

The storage module 20 includes a photo database 201 and a template database 203. The photo database 201 is used for storing digital photographs, which can be obtained from photographing or from other electronic devices (such as the computer). The template database 203 is used for storing multiple template files, such as the examples shown in FIGS. 2A˜2D. But, it should be realized that the examples given are only used for illustration and not meant for limitation. Furthermore, other templates also can be employed. The template is constituted by plural grid cells arranged in a checkered pattern. For each template, the information thereof is recorded in a header, such as how many grid cells are used per row and per column and what the patterns and coordinates of each grid cell are, so that through accessing the header of each template, the detailed construction of the template can be realized and recognized.

The image processing module 30 is controlled by the control module 10 to apply the mosaic process to the digital image selected. It first divides the digital photograph into a number of non-overlapping image cells according to the information stored in the header of the template used. Then, it calculates the average of the brightness or color of each image cell to obtain an average value for each of the image cells.

The color-filling module 40 is controlled by the control module 10 to fill the average color calculated by the image processing module 30 to the corresponding grid cell in the template. That is to say, for an image cell of the digital photograph, after the image processing module 30 calculates the average color value of the image cell, this color value will pass to the color-filling module 40. Then, the color-filling module 40 fills this color to the corresponding grid cell of the template.

The display module 50 is controlled by the control module 10 to provide the displaying function. It can display the processed result of the image processing module 30 and the color-filling module 40.

Through the control of the control module 10, the user can pick up a digital photograph from the photo database 201 and a template from the template database 203. In the above procedure, the control module 10 shows the necessary instructions and the related information, such as the selected digital photograph and template, and the result of the color-filled template, via the display module 50. The control module 10 also can store the processed result in the storage module 20 through the color-filling module 40.

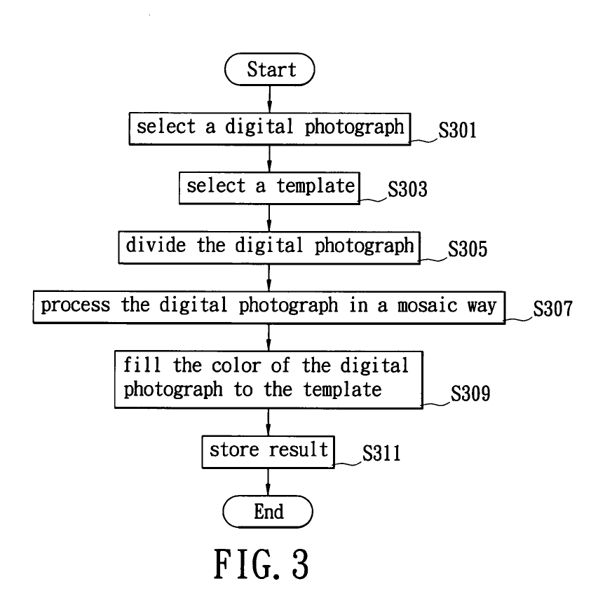

The flow chart of the method for processing the digital photograph in a preferred embodiment according to the present invention is shown in FIG. 3. Please refer to it with FIG. 1 for reference. The steps presented in FIG. 3 are detailed as followed.

First, a digital photograph is selected (S301) by the user. This digital photograph can be obtained from the digital photographing device or from the digital photographs stored in the storage module 20. Then, a template is selected from the template database 203 (S303). Here, the template is constituted by multiple grid cells arranged in a checkered pattern, and each grid cell is represented by a pattern. Then, according to the total number of the grid cells defined in the template selected, the selected digital photograph is divided into the same number of non-overlapping image cells (S305). The image cells of the digital photograph are then processed in a mosaic way (S307), so that each of the image cells only contains one single color. The single color of each image cell is respectively filled to the corresponding grid cell of the selected template (S309). The color-filled template now represents the content of the digital photograph in another form. Finally, this color-filled template is stored as an output file (S311).

In S303 it further includes the step of judging whether the selected template can be identified or not. In this embodiment, if the header of the selected template provides recognizable information, it means this selected template can be used, otherwise, another template should be selected.

In S305 of the embodiment, the division of the photograph selected is based on the template selected. For example, if the selected template is constituted by n×m grid cells arranged in a checkered pattern, the selected digital photograph should be divided into the same number of non-overlapping image cells.

In S309, due to the number of the divided image cells being identical to the number of grid cells of the template, each image cell therefore can be corresponded to a grid cell of the template. Moreover, since each grid cell of the template has the coordinates for representing the location thereof, the color of each image cell of the digital photograph can be used and filled to the corresponding grid cell of the template via the indication of the coordinates.

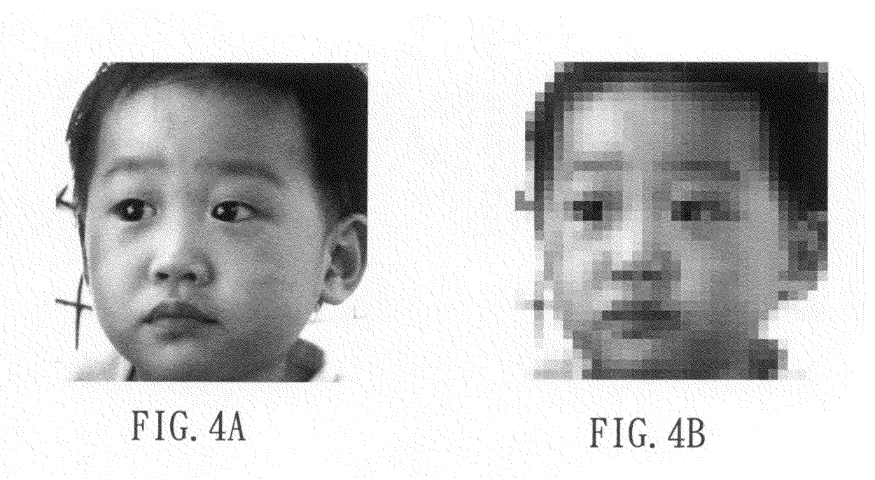

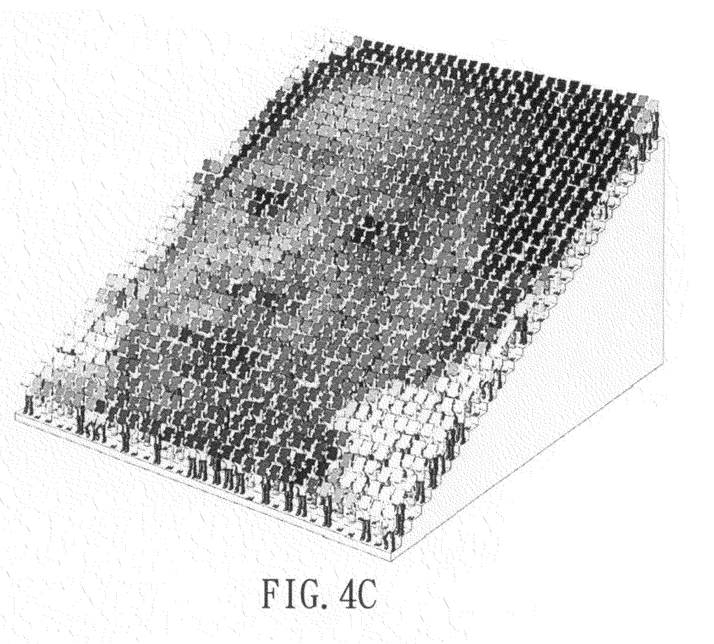

Following, an example is further described for explaining the present invention. Please refer to FIG. 2A and FIGS. 4A˜4C. Here FIG. 4A is a selected digital photograph and FIG. 2A is a selected template. After dividing FIG. 4A into a number of non-overlapping image cells according to the template, the mosaic process is applied to FIG. 4A, and the result is shown in FIG. 4B. Then, the color of each image cell in FIG. 4B is filled to the corresponding cell of the template, as shown in FIG. 2A. The result of color-filled template is shown in FIG. 4C. So, through the processing provided by the present invention, a digital photograph, as shown in FIG. 4A, can be represented in an interesting and creative form, as shown in FIG. 4C.

In the aforesaid description and example, the method and device for processing the digital photograph provide the user with another unique style to display their digital photographs. By processing digital photographs using the present invention, users can have increased amusement and fun with their photographs.

Furthermore, the present invention also can be implemented in the digital photographing device, so that the user can directly process and store the photographing result according to the present invention. In addition, the division of the digital photograph can also be decided by the user without referencing to the template, and for each divided image cell it can be defined to which grid cell of the template it will be filled.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A method for processing digital photographs, comprising steps of:
selecting a digital photograph;
selecting a template, which is defined to have plural grid cells arranged in a checkered pattern;
dividing the digital photograph into non-overlapping image cells arranged in a checkered pattern;
processing each image cell of the digital photograph in a mosaic way; and
respectively filling the color of each image cell of the digital photograph to the corresponding grid cell of the template.

2. The method as claimed in claim 1, wherein the digital photograph is obtained from a digital photographing device or a storage module.

3. The method as claimed in claim 1, wherein the step of selecting a template is to select from a template database.

4. The method as claimed in claim 1, wherein the template provides a header which records data allowing the recognition of the template.

5. The method as claimed in claim 4, wherein the header records the coordinates of each grid cell and the number of grid cells per row and per column of the template.

6. The method as claimed in claim 5, wherein the header further records pattern information of each grid cell in the template.

7. The method as claimed in claim 1, wherein the number of the divided non-overlapping image cells of the digital photograph is identical to the number of grid cells of the template.

8. The method as claimed in claim 7, wherein in the step of filling, the color of each image cell of the digital photograph is filled to the corresponding grid cell of the template according to the indication of the coordinates of each grid cell stored in the template.

9. The method as claimed in claim 1, further comprising the step of: storing the result of the color-filled template as an output file.

10. A device for processing digital photographs, comprising:
a template database for storing multiple templates, each of which defines a number of grid cells arranged in a checkered pattern;
a control module;
an image processing module, controlled by the control module, for dividing the digital photograph selected into a number of non-overlapping image cells and to process the mosaic process to each of the image cells; and
a color-filling module, controlled by the control module, for filling the color calculated by the image processing module of each image cell of the digital photograph to the corresponding grid cell of a selected template.

11. The device as claimed in claim 10, wherein the digital photograph is stored in a photo database.

12. The device as claimed in claim 10, wherein the template provides a header which records data allowing the recognition of the template.

13. The device as claimed in claim 12, wherein the header records the coordinates of each grid cell and the number of grid cells per row and per column of the template.

14. The device as claimed in claim 13, wherein the header further records pattern information of each grid cell in the template.

15. The device as claimed in claim 10, wherein the number of the divided non-overlapping image cells of the digital photograph is identical to the number of grid cells of the template.

16. The device as claimed in claim 15, wherein the color-filling module fills the color of each image cell of the digital photograph to the corresponding grid cell of the template according to the indication of the coordinates of each grid cell stored in the template.

17. The device as claimed in claim 10, further comprising:
a display module, controlled by the control module, for displaying the result of the image processing module and the color-filling module.
